(19) United States
(12) Patent Application Publication
(10) Pub. No.: US 2025/0175859 A1
(43) Pub. Date: May 29, 2025

(54) ASSURANCE OF SERVICE CONTINUITY BY FACILITATING HANDOVERS

(71) Applicant: ZTE CORPORATION, Shenzhen (CN)

(72) Inventors: Lin CHEN, Shenzhen (CN); Mengzhen WANG, Shenzhen (CN); Weiqiang DU, Shenzhen (CN); Wanfu XU, Shenzhen (CN); Tao QI, Shenzhen (CN)

(73) Assignee: ZTE CORPORATION, Shenzhen (CN)

(21) Appl. No.: 19/041,777

(22) Filed: Jan. 30, 2025

Related U.S. Application Data
(63) Continuation of application No. PCT/CN2022/112877, filed on Aug. 16, 2022.

(51) Int. Cl. H04W 36/00; H04W 76/20

(52) U.S. Cl. CPC H04W 36/0033; H04W 36/0061; H04W 76/20

(57) ABSTRACT

Presented are systems, methods, apparatuses, or computer-readable media for facilitating handovers. A first wireless communication node may send, to a second wireless communication node, a handover request message identifying at least one wireless communication device in a user equipment (UE)-to-network relay configuration or an aggregation configuration. The first wireless communication node may receive, from the second wireless communication node, a handover request acknowledgement information identifying the at least one wireless communication device with which a handover is permitted.

### CROSS-REFERENCE TO RELATED APPLICATION

This application claims the benefit of priority under 35 U.S.C. § 120 as a continuation of PCT Patent Application No. PCT/CN2022/112877, filed on Aug. 16, 2022, the disclosure of which is incorporated herein by reference in its entirety.

### TECHNICAL FIELD

The disclosure relates generally to wireless communications, including but not limited to systems and methods for performing handovers.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for facilitating handovers. A first wireless communication node may communicate tunnel configuration information for a forwarding tunnel of a data radio bearer (DRB) with a second wireless communication node. The second wireless communication node may be configured to use the tunnel configuration information to communicate with the first wireless communication node.

In some embodiments, the first wireless communication node may send a sequence number (SN) transfer message to the second wireless communication node. In some embodiments, the SN transfer message may include sending the SN transfer message in response to receiving path switch information from the second wireless communication node. In some embodiments, the SN transfer message may include sending the SN transfer message in response to receiving an end marker from a user plane function (UPF). In some embodiments, the SN transfer message may include sending the SN transfer message in response to sending a RRCReconfiguration message containing the information required to access the second wireless communication node to a wireless communication device. In some embodiments, the SN transfer message may include at least one of a DRB identifier or a downlink (DL) count.

In some embodiments, the first wireless communication node may send, from the second wireless communication node, a packet data convergence protocol (PDCP) protocol data unit (PDU) packet with a PDCP encryption or PDCP compression algorithm configured at the second wireless communication node. In some embodiments, the first wireless communication node may send path switch information to the wireless communication device, responsive to receiving the PDCP PDU from the second wireless communication node. In some embodiments, the path switch information may include a control PDU comprising at least one of: a DRB identifier, an indicator for an uplink (UL) or downlink (DL) direction, a path switch indication, or an indicator for the PDCP encryption or PDCP compression algorithm of the second wireless communication node. In some embodiments, the first wireless communication node may send, to second wireless communication node, the tunnel configuration information and a corresponding DRB identifier, responsive to receiving a forwarding request from the second wireless communication node.

In some embodiments, the first wireless communication node may send a split or duplicated PDCP service data unit (SDU) of a DRB to the second wireless communication node. In some embodiments, the first wireless communication node may send a DL count, to the second wireless communication node, responsive to receipt of a DL PDCP PDU at a lower layer. In some embodiments, the first wireless communication node may perform prior to sending the SN transfer message, at least one of: reordering, duplication detection, discarding, or delivery of a PDCP SDU to a UPF. In some embodiments, the second wireless communication node may perform at least one of the reordering, duplication detection, discarding, or delivery of PDCP SDUs to the UPF after receiving the SN transfer message.

At least one aspect is directed to a system, a method, an apparatus, or a computer-readable medium for facilitating handovers. A first wireless communication node may send, to a second wireless communication node, a handover request message identifying at least one wireless communication device in a user equipment (UE)-to-network relay configuration or an aggregation configuration. The first wireless communication node may receive, from the second wireless communication node, a handover request acknowledgement information identifying the at least one wireless communication device with which a handover is permitted.

In some embodiments, the handover request message may include candidate aggregation-capable UE information comprising at least one of: an identifier for the at least one wireless communication device or a PDU session resource request. In some embodiments, the handover request message may include a mapping of quality of service (QoS) flow with at least one of an identifier for the at least one wireless communication device or a DRB

In some embodiments, the handover request acknowledgement message may identify a RRCReconfiguration message containing the information required to access the second wireless communication node corresponding to the at least one wireless communication device. In some embodiments, the handover request acknowledgement message may identify at least one second wireless communication device with which a handover is not allowed or includes at least one cause value.

At least one aspect is directed to a system, a method, an apparatus, or a computer-readable medium for completing handovers. A first wireless communication device may communicate path switch information with a first wireless communication node. The path switch information may include a control protocol data unit (PDU) comprising at least one of: a DRB identifier, an indicator for an uplink (UL) or downlink (DL) direction, a path switch indication, or an indicator for a PDCP encryption or compression algorithm configured by the second wireless communication node. In some embodiments, the path switch information may identify that a PDCP PDU of a DRB is switched to a PDCP encryption or compression algorithm configured by a second wireless communication node.

In some embodiments, the first wireless communication device may receive the path switch information from at least one of a second wireless communication node or via a second wireless communication device. In some embodiments, the first wireless communication device may send, to the first wireless communication node via a second wireless communication device, the path switch information.

In some embodiments, the first wireless communication device may send the PDCP PDU of the DRB to the first wireless communication node via a second wireless communication device. In some embodiments, the first wireless communication device may receive, from the first wireless communication node, the path switch information responsive to the first wireless communication node sending a sequence number (SN) transfer message for the DRB or the first wireless communication node receiving a user equipment (UE) context release from a second wireless communication node.

In some embodiments, the first wireless communication device may send path switch information for the DRB to the first wireless communication node via a second wireless communicate device. In some embodiments, the first wireless communication device may receive DL packets of a DRB from the first wireless communication node via the second wireless communication device.

In some embodiments, the first wireless communication device may maintain, using a PDCP entity, a first function for DL packets via a direct path and a second function for DL packets via an indirect path. In some embodiments, the first wireless communication device may maintain a third function to perform at least one of the reordering, duplication detection, discarding, or delivery of PDCP service data units (SDUs) to an upper layer.

In some embodiments, the first wireless communication device may maintain a PDCP SN allocation for UL packets via a direct path and an indirect path. In some embodiments, the first wireless communication device may maintain a first configuration for processing split or duplicated UL packets via the direct path and a second configuration for processing the split or duplicated UP packets via the indicated path. In some embodiments, the first configuration and the second configurations may be separate PDCP configurations to perform at least one of compression, ciphering, and addition of robust header compression (ROHC) header.

In some embodiments, the first wireless communication device may receive a first DL packet via a second wireless communication device over an indirect path at least partially concurrent with a second DL packet from a second wireless communication node over a direct path. In some embodiments, the first wireless communication device may receive, from a second wireless communication node, path switch information for a DRB.

In some embodiments, the first wireless communication device may send the path switch information to the first wireless communication node via a second wireless communication device. In some embodiments, the first wireless communication device may receive at least one of radio link channel (RLC) SDU or PDU from the second wireless communication device, concurrent with or prior to the second wireless communication device reestablishing the RLC.

In some embodiments, the first wireless communication device may receive a status report for the DRB from the second wireless communication device. In some embodiments, the status report may include at least one of: an indicator identifying whether a PDCP PDU is successfully transmitted to the first wireless communication node; an identifier for the first wireless communication device; a DRB identifier; a UL count; or a receiver status of a UL PDCP SDU.

In some embodiments, the first wireless communication device may retransmit a PDCP PDU in accordance with the PDCP status report. In some embodiments, retransmitting the PDCP PDU may include transmitting the PDCP PDU to the second wireless communication device for retransmission of a corresponding, missing PDCP PDU. In some embodiments, the first wireless communication device may refrain determination of successful transmission of the UL PDCP data PDU to the second wireless communication device, responsive to successful transmission of a corresponding UL PDCP PDU to the second wireless communication device.

In some embodiments, the first wireless communication device may receive a RRCReconfiguration message containing the information required to access the second wireless communication node from the first wireless communication node to a plurality of wireless communication devices in an aggregation configuration. In some embodiments, the first wireless communication device may perform an aggregation-based communication with the plurality of wireless communication devices, responsive to a RRC reconfiguration completion of each of the plurality of wireless communication devices.

In some embodiments, the first wireless communication device may configure a path to at least one of: suspend transmission on a direct path, re-route packets to an indirect path, or set an indirect path as a primary path. In some embodiments, the first wireless communication device may receive a configuration from the first wireless communication node. In some embodiments, the configuration may include at least one of the following: add or modify or remove the direct path, add or modify or remove the indirect path, activate or deactivate the direct path, activate or deactivate the indirect path. In some embodiments, the first wireless communication device may receive, via the first path to the first wireless communication node, a PDCP SDU or PDU in a user equipment (UE)-to-network relay configuration or an aggregation configuration, at least partially concurrent with the deactivation of the first path.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an example system for a user equipment (UE)-to-network relay in accordance with an illustrative embodiment;

FIG. 4 illustrates a block diagram of an example system for a user equipment (UE) aggregation in accordance with an illustrative embodiment;

FIG. 5 illustrates a block diagram of an example system for handover (HO) of a user equipment (UE1) with multi-path transmission and reception in accordance with an illustrative embodiment;

FIGS. 6A and 6B illustrate a communication diagram of a handover procedure with a data radio bearer (DRB1) via a direct path in accordance with an illustrative embodiment;

FIGS. 7A and 7B illustrate a communication diagram of a handover procedure with a data radio bearer (DRB2) via an indirect path, in accordance with an illustrative embodiment;

FIG. 8A illustrates a block diagram of a data forwarding path of a multi-path user equipment (UE1) before a sequence number (SN) status transfer, in accordance with an illustrative embodiment;

FIG. 8B illustrates a block diagram of a data forwarding path of a multi-path user equipment (UE1) after a sequence number (SN) status transfer, in accordance with an illustrative embodiment;

FIG. 9 illustrates a block diagram of an example system for handover (HO) of multiple user equipment (UE1 and UE2) with multi-path transmission and reception in accordance with an illustrative embodiment;

FIG. 10 illustrates a flow diagram of a method of facilitating handovers in accordance with an illustrative embodiment; and

FIG. 11 illustrates a flow diagram of a method of completing handovers in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

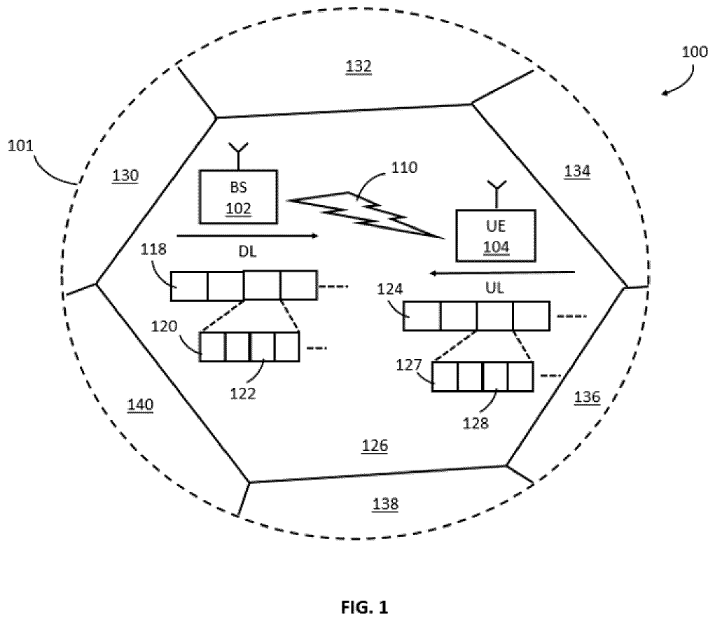

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

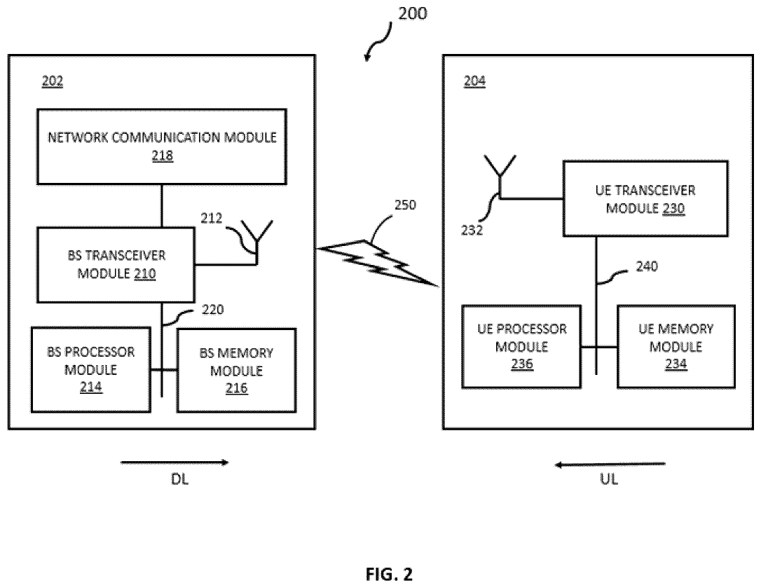

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Performing Handovers

Presented herein are systems and methods for assuring service continuity for a user equipment (UE) with a multi-path transmission/reception in a network, focusing on the UE handover (HO), re-establishment, and path switch.

With the wireless multimedia services, demands of high data rate services may significantly increase. Under such conditions, requirements of system capacity and coverage of conventional cellular network may become higher. On the other hand, due to various application scenarios (e.g., public safety, social network, short distance data sharing, and content services), demands of proximity services allowing users to acknowledge or to communicate with adjacent users also increase.

However, there may be difficulty with a cellular network has in supporting the high data rate services and the proximity services. As a result, device-to-device (D2D) communication technology may be used to serve such demands. By adopting the D2D technology, the burden of the cellular network can be decreased, power consumption of user equipment can be reduced, and data rate can be increased and robustness of network infrastructures can be improved, so as to fulfill the demands of the high data rate services and the proximity services. The D2D technology may also be called the proximity service (ProSe) or sidelink communications and an interface between equipment may be referred to as a PC5 interface.

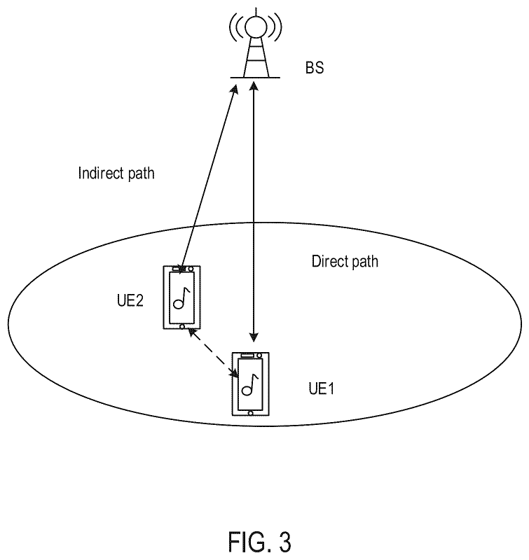

For supporting applications and services with broader ranges, a sidelink based relay communication may be used to extend the coverage and to improve power consumption of the network. For example, the sidelink based relay communication may be applied to indoor relay communication, smart farming, smart factory and public safety services, among others. Referring now to FIG. 3, depicted is a block diagram of an example system for a user equipment (UE)-to-network relay. As shown, the system for applying the sidelink based relay communication may include comprise user equipment (UE) (e.g., UE1 shown) in an area with weak or no coverage. Under such conditions, the UE1 may be allowed to communicate with network (e.g. base station (BS) shown) via a nearby UE2 covered by the network. As a result, the coverage of the network may be extended and the capacity of the network is enlarged. In this scenario, the UE2 may referred to as a UE-to-Network relay and the UE1 may be referred to as remote UE. On the other hand, if the remote UE is in coverage, the multi-path relay can be supported. In coverage remote UE may be connected to network via both direct (e.g., data directly transmitted between remote UE and network) and indirect (e.g., data forwarded via relay UE) paths, and may have a potential to improve the reliability and robustness as well as throughput.

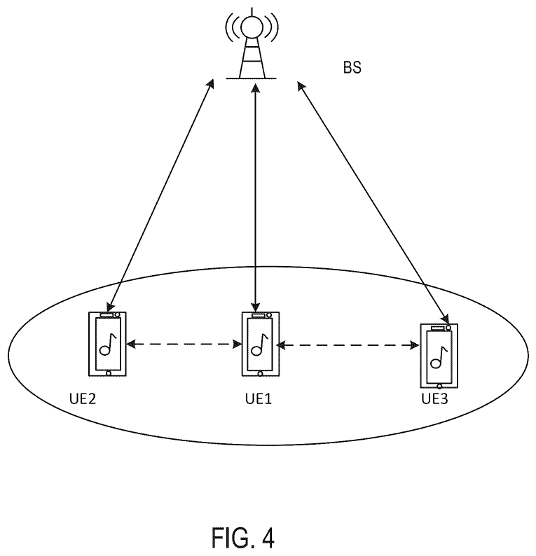

This multi-path relay can also be utilized for UE aggregation where a UE is connected to the network via direct path and via another UE using a non-standardized UE-UE interconnection. Referring now to FIG. 4, depicted is a block diagram of an example system for a user equipment (UE) aggregation. As shown, the system for applying UE aggregation may comprise one user equipment (UE) (e.g., UE1 as shown) which aggregates other UEs (e.g., UE2 and UE3 as shown) for its upllink transmission or downlink reception from the network. Here, the interconnection between UE1 and UE2 or between UE1 and UE3 may be based on sidelink, Wifi, Bluetooth or wireline connection, among others. Nevertheless, the interconnection between UEs can be an ideal connection. UE aggregation may provide applications requiring high UL bitrates on 5G terminals, in cases when normal UEs are too limited by UL UE transmission power to achieve required bitrate, especially at the edge of a cell. Additionally, UE aggregation can improve the reliability, stability and reduce delay of services as well.

Presented herein methods, systems, and devices for assuring service continuity for a UE with multi-path transmission and reception (e.g., indirect path via UE-to-network relay or UE aggregation) in a network, focusing on the UE path switch, HO, and re-establishment.

The motivation of UE multi-path transmission may be that UE may be limited in an uplink (UL) transmission (Tx) capability and one UE may be associated with many UEs for UE aggregation or connected with many relay UE for UE-to-Network relay. To support higher requirement of UL traffic, including data rate, latency, and reliability, the multi-path transmission may be used. In particular, the UE may be connected to the network and may perform the data traffic transmission or reception with the network via a direct path and via one or more indirect path (e.g., data traffic forwarded by another UE). The UE-UE interconnection can be based on sidelink connection or using a non-standardized connection. To support this multi-path scenario, the service continuity issues, such as HO, re-establishment, and path switch, may be used.

### A. Handover Procedure for a Multi-Path UE1

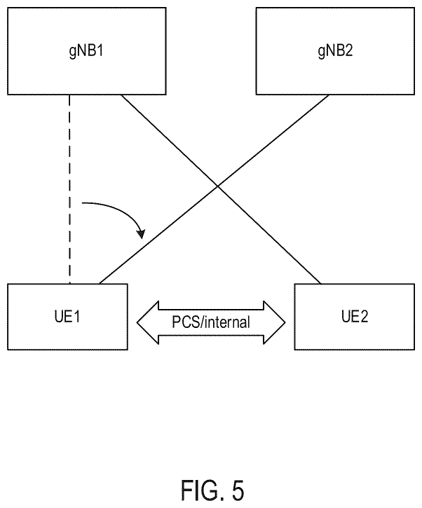

Referring now to FIG. 5, depicted is a block diagram of an example system for handover (HO) of a user equipment (UE) with multi-path transmission and reception. Generally speaking, the UE1 involved in the aggregation may have wireline connection or may be co-located with other aggregation capable UE, such as UE2. In some embodiments, the UE1 may be connected with UE2 via PC5 connection. It may be assumed that UE1 is the traffic originating or terminating UE while the UE2 is the aggregated UE or relay UE. When the UE1 moves, the UE1 may perform HO from gNB1 to gNB2 as shown. However, the aggregated UE2 or relay UE2 may be still served by the gNB1. In this case, the inter-gNB interaction may be considered to ensure the service continuity.

### I. Handover Procedure for Multi-Path UE1 with a Data Radio Bearer (DRB1) via a Direct Path

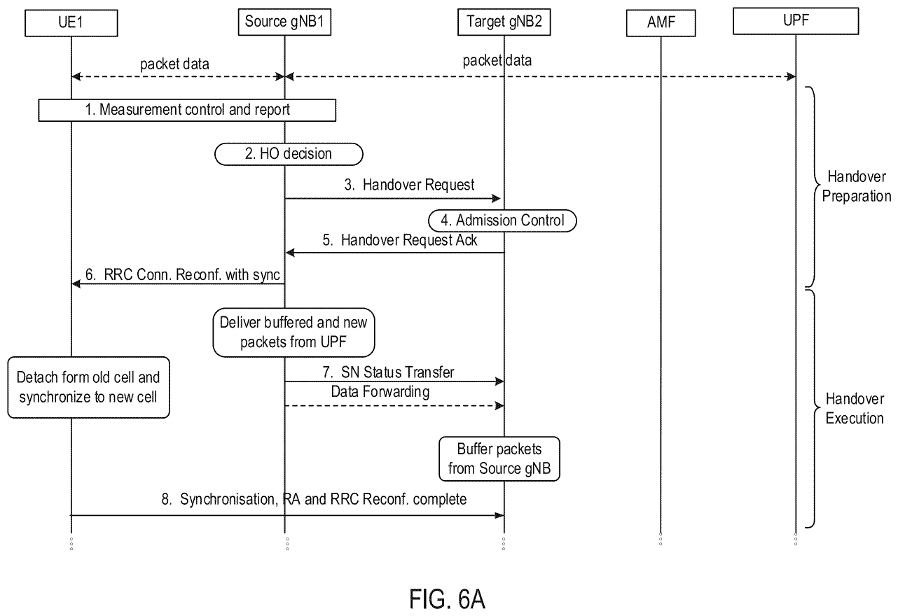

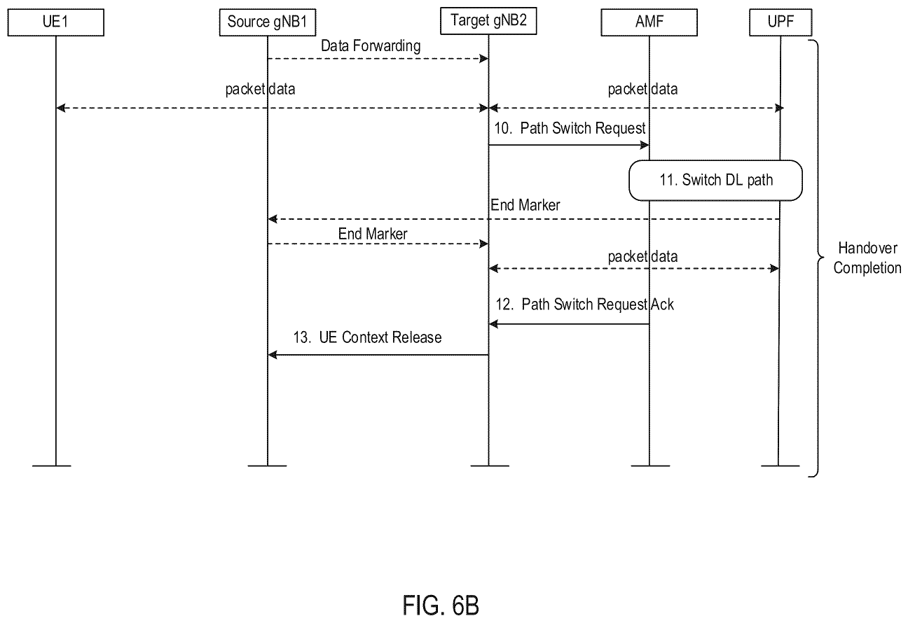

Referring now to FIG. 6, depicted is a communication diagram of a handover procedure for a multi-path UE1 with a data radio bearer (DRB1) via a direct path. As shown, the UE1 may perform the HO from gNB1 to gNB2. In this example, the UE1 and UE2 may be aggregated to transmit the UE1's traffic. UE1's data radio bearer (DRB1) may be a radio link control (RLC) an acknowledge mode (AM) mode and may be transmitted via direct path. The UE1 may perform HO from gNB1 to gNB2 while the UE2 remains served by gNB1. After UE1 receive the HO command from gNB1, UE1 may begin to access the gNB2 and no longer receive or transmit packet from or to gNB1. The service continuity of DRB1 transmitted via direct path may be ensured as detailed herein below.

As shown, after the gNB1 sends the HO command (e.g., a radio resource control reconfiguration (RRCReconfiguration) with synchronization) to UE1, source gNB1 may continue receive a downlink (DL) packet of DRB1 from a core network, 5GC. The source gNB1 may send the sequence number (SN) status transfer message to target gNB2. The SN status transfer message contains the following fields: ID of DRB, downlink (DL) COUNT for DRB, uplink (UL) COUNT, receiver status of UL packet data convergence protocol (PDCP) service data unit (SDU). Among them, the DL COUNT for DRB may indicate the next PDCP SN that the target gNB2 is to assign to new PDCP SDUs that do not have a PDCP SN yet. UL COUNT may indicate the PDCP-SN and Hyper Frame Number of the first missing UL SDU. The target next generation radio access network (NG-RAN) node may not deliver any uplink packet which has a PDCP-SN lower than the value contained within the UL COUNT Value to 5GC. Receiver status of UL PDCP SDU may include a first bit indicating the status of the SDU after the First Missing UL PDCP SDU as indicated by UL COUNT.

Source the gNB1 may forward the DL and UL packets of DRB1 to the target gNB2. For the DL packet that has been assigned PDCP SN but the acknowledgement of successful reception has not been received by source gNB1, the source gNB1 may forward the corresponding PDCP SDU with corresponding PDCP SN in the general packet radio service tunneling protocol user plane (GTP-U) extension header. For the DL packet that received from UPF later, the source gNB1 may forward the corresponding PDCP SDU without PDCP SN and target gNB2 will assign the PDCP SN to PDCP SDU. Similarly, the source gNB1 may forward the UL PDCP SDUs that is out of order to target gNB2. The corresponding PDCP SN of UL PDCP SDU can be included in the GTP-U extension header.

The UE1 may perform the reconfiguration with synchronization and security key refresh, involving random access (RA) to the target gNB2, a media access control (MAC) reset, and refresh of security and re-establishment of RLC and PDCP triggered by explicit L2 indicators. To be specific, when the indication of successful completion of random access towards target cell is received from lower layers, the UE1 may perform PDCP entity re-establishment (if reestablishPDCP is set) for DRB1. For DRB1, the PDCP re-establishment for UL PDCP Tx entity may reset the robust header compression (ROHC) protocol for uplink, apply the ciphering and or integrity protection algorithm and key provided by upper layers during the PDCP entity re-establishment procedure.

In addition, for DRB1, the first PDCP SDU for which the successful delivery of the corresponding PDCP Data protocol data unit (PDU) may not been confirmed by lower layers. In such a case, the UE1 may perform retransmission or transmission of all the PDCP SDUs already associated with PDCP SNs in ascending order of the COUNT values associated to the PDCP SDU prior to the PDCP entity re-establishment. On the other hand, the DL receiving PDCP entity of UE1 may process the PDCP Data PDUs that are received from lower layers due to the re-establishment of the lower layers. The entity may also apply the ciphering or integrity protection algorithm and key provided by upper layers during the PDCP entity re-establishment procedure.

After the PDCP re-establishment, UE1 may also transmit the subsequent UL PDCP PDU to target gNB2. The target gNB2 may deliver the UL PDCP PDU to a user plane function (UPF). On the other hand, the target gNB2 may send the PDCP status report (similar to the SN status transfer received from gNB1) to the UE1. Upon receiving the status report, the UE1 may consider for each PDCP SDU, if any, with the bit in the bitmap set to ‘1’, or with the associated COUNT value less than the value of a fixed-mobile convergence (FMC) field as successfully delivered. The UE1 may discard the PDCP SDU along with the corresponding PDCP Data PDU. If the corresponding PDCP Data PDU has already been submitted to lower layers, the discard may be indicated to lower layers.

From the perspective of the target gNB2, the target gNB2 may transmit the DL PDCP SDU forwarded by source gNB1 to UE1. On the other hand, the gNB2 may send a PATH SWITCH REQUEST message to AMF to inform that the UE1 has changed cell. The UPF may switch the downlink data path to the gNB2. The UPF may send one or more “end marker” packets on the old path to the source gNB1 and then can release any user plane or tunnel (TNL) resources towards the source gNB1.

Upon reception of the PATH SWITCH REQUEST ACKNOWLEDGE message from the access and mobility management function (AMF), the legacy HO behavior may be that the target gNB2 sends the UE CONTEXT RELEASE to inform the gNB1 about the success of the handover. The gNB1 can then release radio and C-plane related resources associated to the UE context. However, for the UE aggregation and UE-to-Network relay scenario, more issues may be considered.

### II. Handover Procedure for Multi-Path UE1 with a Data Radio Bearer (DRB2) Via an Indirect Path

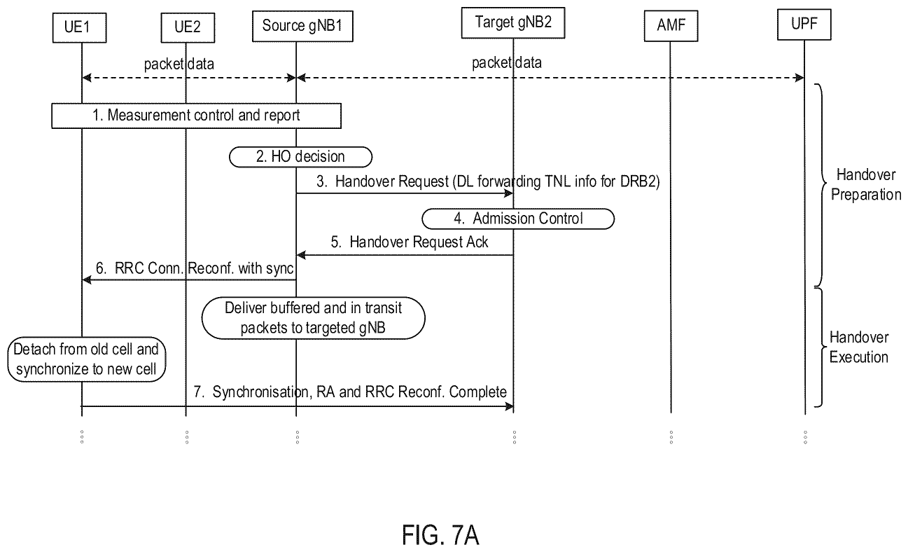

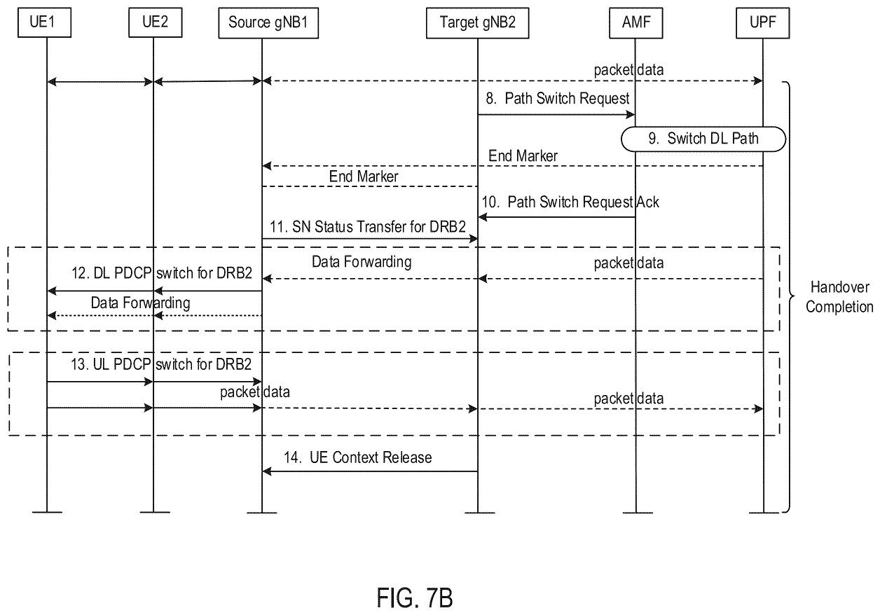

Referring now to FIGS. 7A and 7B, depicted is a communication diagram of a handover procedure for a multi-path UE1 with a data radio bearer (DRB2) via an indirect path. As shown, the UE1 may perform HO from source gNB1 to target gNB2. In this scenario, the UE1 may be the remote UE and the UE2 may be the relay UE. The UE2 may help to transmit the UE1's traffic. For example, UE1's DRB2 may be transmitted via indirect path (via UE2). The UE1 may perform HO from source gNB1 to target gNB2 while UE2 remains served by gNB1. After the UE1 receives the HO command from source gNB1, the UE1 begin to access the target gNB2 and no longer receive or transmit packet from or to source gNB1. The service continuity of DRB2 transmitted via indirect path may be ensured as detailed herein below.

For the UE1's DRB2 that is to be delivered via the UE2, since the UE2 does not perform HO, the UE1's data packet for DRB2 may not be forwarded from source gNB1 to target gNB2. Thus, the DL data forwarding of DRB2 packet between gNB1 and gNB2 can be withheld until the downlink data path is switched from source gNB1 to target gNB2, and the gNB2 may begin to receive the DL data packet of DRB2 from UPF. At this time, the target gNB2 may send the path switch success information to source gNB1 and source gNB1 may send the SN status report of DRB2 to target gNB2 in return. In some embodiments, the source gNB1 may send the SN status report of DRB2 to target gNB2 upon receiving the end marker from UPF as shown. Upon receiving the SN status report of DRB2, the target gNB2 may begin to assign the PDCP SN, perform the PDCP processing (e.g., encryption and compression based on target gNB2's configuration) for DRB2, or forward the DL PDCP PDU packet of DRB2 to source gNB1. With regard to source gNB1, the gNB1 may first deliver the DL packet for UE1's DRB2 received directly from UPF to UE2 with the PDCP encryption or compression algorithm configured by source gNB1.

After that, upon receiving the PDCP PDU of DRB2 forwarded by target gNB2, source gNB1 may send PDCP switch information to UE1 as shown. The PDCP switch information may be forwarded by UE2 via an indirect path or forwarded by target gNB2. The PDCP switch information may include the DRB ID, UL or DL direction, and or PDCP switch indication. The PDCP switch information may be in the form of PDCP control PDU. The PDCP switch information may indicate that the PDCP encryption, decryption, compression, or decompression of DRB2 has been switched to target gNB2. Afterward, the source gNB1 may deliver the DL packet for UE1's DRB2 forwarded by gNB2 to UE2. Based on this approach, the DL data forwarding path of DRB2 before path switch may be: from the UPF, to the gNB1, to the UE2, and then to the UE1. The DL data forwarding path of DRB2 after path switch may be from the UPF, to the gNB2, to the gNB1, to the UE2, and then to the UE1.

On the other hand, for the UL packet of UE1's DRB2 received from the indirect path, the UL packet can be forwarded by source gNB1 to the UPF directly. However, if the UE1 has already connected to target gNB2, the UE1 may switch to the PDCP configuration of target gNB2 and perform the encryption or compression accordingly. In this case, the PDCP PDU of UE1's DRB2 may be forwarded by source gNB 1 to target gNB2, and the PDCP entity of UE1's DRB2 at target gNB2 may perform the PDCP decryption or decompression. In order to keep the source gNB1 informed of when to forward the UL PDCP PDU to target gNB2, the UE1 may send PDCP switch information to source gNB1 as shown i. The PDCP switch information may be forwarded by the UE2 via indirect path. The PDCP switch information may include the DRB ID, UL or DL direction, or PDCP switch indication, among others. The PDCP switch information may be in the form of PDCP control PDU. The PDCP switch information may indicate that the PDCP PDU of DRB2 has switched to target gNB's configuration.

After the UE1 sends the PDCP switch information to the source gNB1, the UE1 may begin to process the data packet of DRB2 with target gNB2's PDCP configuration and may send the PDCP PDU to source gNB1 via the UE2. From the perspective of source gNB1, the gNB1 may begin to forward the subsequent PDCP PDU of DRB2 to target gNB2 after the gNB1 receives the PDCP switch information of DRB2. The UL data forwarding path before or during UE1 HO execution may be from the UE1, to the UE2, to the gNB1, and finally to the UPF. The UL data forwarding path after HO may be from the UE1, to the UE2, to the gNB1, to the gNB2, and then to the UPF.

The UL or DL forwarding tunnel for UE1's DRB2 can be established during HO preparation procedure. For example, when source gNB1 sends the HO request message to target gNB2, the gNB1 may include the DL Forwarding UP tunneling (TNL) Information and the corresponding DRB ID. In some embodiments, if the target gNB2 admits the quality of service (QoS) flows of DRB2 and still allows the indirect path delivery of UE1's DRB2 via the UE2, the target gNB2 may send the DL forwarding request to source gNB1, and then the source gNB1 may send the DL Forwarding UP TNL Information and corresponding DRB ID to the target gNB2.

As shown, after UE1's HO, the gNB1 may still forward the UE1's UL packet to gNB2 and may receive the DL packet of UE1's DRB2 from gNB2. In addition, gNB1 may map the DL packet of UE1's DRB2 to UE2's Uu RLC channel and map the UL packet of UE1's DRB2 to GTP-U tunnel towards gNB2. Based on this, gNB1 may keep the association between UE1 and UE2 as well as the mapping configuration as part of UE2's context. For the other UE1's context, the UE1's context can be removed by gNB1 upon receiving the UE context release message from gNB2.

It should be noted that it may not matter whether the DRB2 is a RLC unacknowledged mode (UM) mode or RLC acknowledge mode (AM) mode. The DRB2 may keep the PDCP SN between gNB1 and gNB2. The data forwarding between gNB1 and gNB2 mentioned above can be applied. For DRBs via direct path and indirect path, both gNB1 and gNB2 may maintain the PDCP entity for different DRBs of UE1 during the HO execution procedure. The SN status transfer may be delivered twice for the DRBs via direct and indirect path respectively. The DRB via direct path may use the PDCP on target gNB while the DRB via indirect path may use the PDCP on the source gNB.

### III. Handover Procedure for Multi-Path UE1 With a Data Radio Bearer (DRB3) for Splitting or Duplication

As with the scenario depicted in FIG. 5, the UE1 may perform HO from gNB1 to gNB2. In this case, the UE1 and UE2 may be aggregated to transmit the UE1's traffic. UE1's DRB3 may be configured as a split or duplicated bearer and is transmitted via both direct path and indirect path. The UE1 may perform HO from source gNB1 to target gNB2 while UE2 remains served by gNB1. After the UE1 receives the RRCRconfiguration with synchronization from gNB1, the UE1 may begin to access the target gNB2 and may no longer receive or transmit packet directly from or to the gNB1. The service continuity of DRB3 transmitted via both direct and indirect path may be ensured as detailed herein below.

The DRB3 of UE1 may be configured with data split or duplication and transmitted via direct and indirect path respectively. The following two scenarios can be considered.

Under the first scenario, after the source gNB1 send the RRCRconfiguration with sync to the UE1, the source gNB1 may send the SN status transfer to target gNB2. Then gNB2 may become responsible for the PDCP SN assignment and the data split or duplication. On the other hand, the UE1 may no longer transmit and receive directly via the source gNB1. Instead, the UE1 may begin to connect to target gNB2 and may perform the RRC reconfiguration from target gNB2. It means that the UL data forwarding path may be from the UE1, to the UE2, to the gNB1, to the gNB2, to the UPF and from UE1, to the gNB2, to the UPF. Furthermore, the DL data forwarding path during HO execution may be from the UPF, to the gNB1, to the gNB2, to the gNB1, to the UE2, and to the UE1 and from the UPF->gNB1->gNB2->UE1. The data forwarding for indirect path transmission may be back and forth between gNB1 and gNB.

Under the second scenario, to reduce the data forwarding path during the HO, a dual active protocol stack (DAPS)-like HO may be considered. For example, the data packet of DRB3 via indirect path may utilize the PDCP configuration of source gNB1 while the data packet via direct path may utilize the PDCP configuration of target gNB2. For the DL packets of DRB3, the UE1 may receive them from target gNB2 and UE2. The UE1's PDCP entity may maintain separate security and ROHC header decompression functions for packets from direct and indirect path respectively, while maintaining common functions for reordering, duplicate detection and discarding, and PDCP SDUs in-sequence delivery to UE1's upper layers. For the UL packet, the UE1 may maintain a common PDCP SN allocation. The split or duplicated PDCP SDUs to be forwarded to UE2 and target gNB2 may be processed with separate PDCP configurations for ROHC header compression, ciphering, and adding PDCP header, among others.

After the source gNB1 sends the RRCReconfiguration with synchronization to the UE1, the source gNB1 may send the early SN transfer including the DRB ID for DRB3 and the DL COUNT to target gNB2. In addition, the source gNB1 may forward the split or duplicated PDCP SDU of DRB3 to target gNB2. The target gNB2 may perform encryption or compression for the PDCP SDU forwarded by source gNB1. If the DRB3 is configured for PDCP duplication, the source gNB1 may also send the early SN transfer including the discard DL count to target gNB2 later, if certain DL PDCP SDU has been confirmed to be received by lower layers from indirect path.

On the other hand, the source gNB1 may continue to transmit the split or duplicated PDCP PDU of DRB3 with the PDCP configuration of source gNB1 via indirect path to UE2. As such, the UE1 may receive the DL packet from both UE2 and target gNB2 for a while. The source gNB1 may send the SN status transfer upon receiving the end marker from UPF. Afterward, the UPF may deliver the DL packet directly to target gNB2 and target gNB2 make take the responsibility of PDCP SN assignment and data split or duplication operation. For the UL packet, before the SN status transfer is sent to target gNB2, the receiving (Rx) PDCP entity at gNB1 may be responsible for the reordering, duplicate detection and discard, and PDCP SDUs in-sequence delivery to UPF. Afterward, the Rx PDCP entity at gNB2 may be responsible for the reordering, duplicate detection and discard, and PDCP SDUs in-sequence delivery to UPF.

For the uplink, the UE1 may identify when to totally utilize the PDCP encryption or compression configuration from target gNB2. Under one approach, the target gNB2 may send the UL PDCP switch information for DRB3 to the UE1, after the gNB2 receives the SN status transfer for DRB3 or before the target gNB2 sends the UE context release to source gNB1. The UE1 may send the UL PDCP switch control PDU to gNB1 via indirect path. Upon receiving the UL PDCP switch information for DRB3, the gNB1 may forward the subsequent PDCP PDU of DRB3 to gNB2.

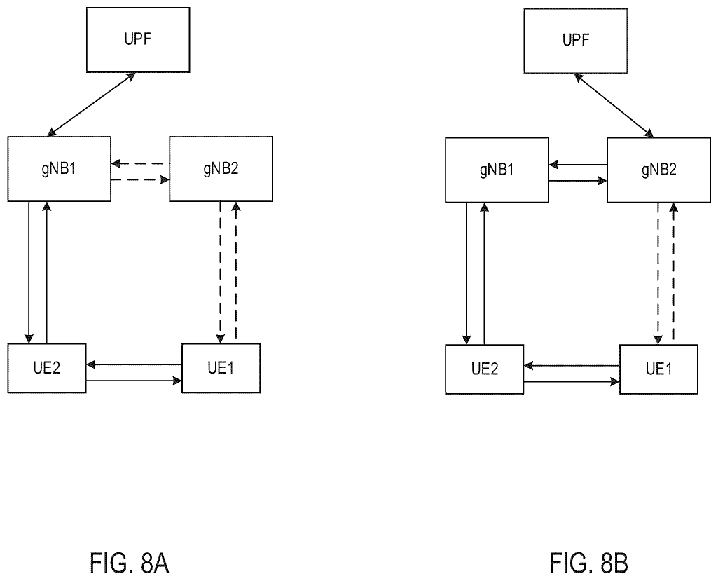

Referring now to FIGS. 8A and 8B, depicted are block diagram of a data forwarding path of a multi-path user equipment (UE1) before the SN status transfer (FIG. 8A) and after the SN status transfer (FIG. 8B). As shown, the DL data forwarding path of UE1's DRB3 during UE1 HO execution and before the SN status transfer is sent to target gNB2 may be from the UPF, to the gNB1, to the UE2, and then to UE1 for the indirect path and from the UPF, to the gNB1, to the gNB2, and then UE1 for direct path. The DL data forwarding path after the SN status transfer is sent to gNB2 and UPF path is switched to target gNB2 may be from the UPF, to the gNB2, and then to UE1 for direct path and from the UPF, to the gNB2, to the gNB1, to the UE2, and then to the UE1 for indirect path.

For the uplink, the UL data forwarding path during UE1 HO execution and before the SN status transfer is sent to target gNB2 may be: from the UE1, to the UE2, to the gNB1, and then to the UPF for indirect path and from the UE1, to the gNB2, to the gNB1, and then to the UPF. The UL data forwarding path after the SN status transfer is sent to target gNB2 and UPF path is switched to gNB2 may be: from the UE1, to the UE2, to the gNB1, to the gNB2, and then to the UPF for indirect path and from the UE1, to the gNB2, and to then the UPF for direct path.

After the HO completion, it may be possible to utilize the DAPS like UL or DL packet transmission. Compared with the above procedure, there may be following differences. For the DL packet, the gNB2 may forward the split or duplicated PDCP SDU with PDCP SN to gNB1 and gNB1 may perform the PDCP encryption and compression. Similarly, for the UL packet, the UE1 may perform the PDCP encryption and compression to be delivered via direct and indirect path separately with gNB1 and gNB2's configuration. The gNB1 may forward the UL PDCP SDU to gNB2. As such, the gNB1 may keep the UE1's context, especially for the PDCP encryption or decryption, compression or decompression, and PDCP entity, among others. In addition, when to switch the PDCP of UE1 to a pure target configuration may not be considered any more.

### B. Handover Procedures for Multiple, Multi-Path User Equipment (UE1 and UE2)

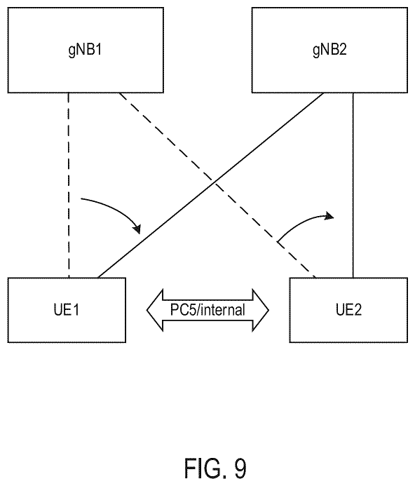

Referring now to FIG. 9, depicted is a block diagram o of an example system for handover (HO) of multiple user equipment (UE1 and UE2) with multi-path transmission and reception. In general, the UE1 involved in the aggregation may have a wireline connection or may be co-located with other aggregation capable UE, such as UE2. In some embodiments, the UE1 may be connected with UE2 via PC5 connection. It may be assumed that UE1 may be the traffic originating or terminating UE while the UE2 may be the aggregated UE or relay UE. When the UE1 moves, the UE1 may perform HO from gNB1 to gNB2 as shown. With regard to the aggregated UE2 or relay UE2, the UE2 may also perform HO. In this case, UE1 and UE2 may perform HO one by one or perform group handover.

### I. Handover Procedure for Multi-Path UE1 and UE2 With a Data Radio Bearer (DRB2 or DRB3) Using Radio Link Control (RLC) Re-Establishment

The HO procedure here may be similar to the one described herein in conjunction with FIG. 6. Under this scenario, the UE1 may be the remote UE and UE2 may be the relay UE. The UE2 may help to transmit the UE1's traffic. For example, UE1's DRB2 may be transmitted via indirect path (via UE2). When UE1 has already performed HO from source gNB1 to target gNB2, the UL data forwarding path for UE1's DRB2 may be from UE1, to the UE2, to the gNB1, to the gNB2, and then to the UPF. Conversely, the DL data forwarding path for UE1's DRB2 may be from the UPF, to the gNB2, to the gNB1, to the UE2, and then to the UE1. When UE2 is to also perform the HO, the gNB1 may prioritize the UE2's HO to gNB2. The service continuity of DRB2 or DRB3 during the HO of UE2 may be ensured as detailed herein below.

During the HO preparation phase, the source gNB1 may send the HO request for UE2 to the target gNB2. The target gNB2 may send the HO request acknowledgement to gNB1 and allows the HO of UE2. After that, the gNB2 may no longer forward the PDCP packet of UE1's DRB2 to gNB1. Instead, the gNB2 may buffer the DL packet for a while. After the UE2 access gNB2, gNB2 may send the packet of UE1's DRB2 via indirect path to UE2. With regard to the UL packet, upon receiving the RRC reconfiguration with synchronization, the UE2 may not send the UL packet to gNB1 anymore. Instead, the UE2 may connect to gNB2 and may continue to send the UL PDCP packet for UE1's DRB2 to gNB2.

For the Uu RLC channel of UE2 used for UE1's UL PDCP packet transmission, the RLC re-establishment may be performed, meaning that all the RLC SDUs and RLC PDUs are to be discarded. In addition, all the state variables of RLC entity may be reset to initial values. To ensure service continuity, the following methods can be considered.

Under the first method, during the RLC re-establishment, the UE2 may first reset the state variables and timers. However, the RLC SDU or PDU may still be transmitted or retransmitted to gNB2. Meanwhile, for the RLC SDU or PDUs received in the RLC receiving (Rx) entity, UE2 may deliver the SDU or PDUs to the UE1. Subsequently, the UE1 and gNB2 may assure the lossless packet delivery via the PDCP operation.

Under the second method, for the RLC SDU or PDUs received in the RLC Rx entity, UE2 may deliver SDU or PDUS to the UE1 before corresponding RLC channel re-establishment. In addition, UE2 may send the PDCP status report of UE1's DRB2 to UE1. The PDCP status report may indicate which PDCP PDU has not been successfully transmitted to gNB1. The status report may include any combination of the following fields: the UE ID, DRB ID, UL count, and Receiver status of UL PDCP SDU, among others. Upon receiving the PDCP status report from UE2, the UE1 may perform PDCP re-transmission based on the PDCP status report. To support this, when UE1 successfully sends the UL PDCP PDU to UE2, the UE1 may not regard that the successful delivery of the corresponding PDCP Data PDU has been confirmed.

Under the third method, when UE1 successfully sends the UL PDCP PDU to UE2, UE1 may not regard that the successful delivery of the corresponding PDCP Data PDU has been confirmed. In addition, after the UE2 performs HO and connects to gNB2, the gNB2 may send the UL PDCP status report to UE1, and UE1 may perform the UL PDCP retransmission for the missing PDCP PDU.

### II. Handover Procedure for Multi-Path UE1 and UE2 With a Data Radio Bearer (DRB3) Using Group Handover

The HO procedure here may be similar to the one described herein in conjunction with FIG. 6. In this scenario, the UE1 and UE2 may be aggregated and UE1 may be the traffic originating UE and UE2 may help to deliver the UE1's traffic. For example, UE1's DRB3 may be transmitted via both direct and indirect path (via UE2). When UE1 and UE2 are to move together and performed HO jointly from source gNB1 to target gNB2, the service continuity of DRB3 during the HO of UE2 may be ensured as detailed herein below.

The traffic originating UE1 may send the measurement result of not only itself but also other aggregated UEs or candidate aggregation-capable UE, such as UE2, to gNB. The source gNB1 may send HO request to gNB2, which include not only the traffic originating UE but also other aggregating UEs or candidate aggregation-capable UE information (e.g., UE ID or the PDU session resource requirement of the aggregated UEs). In addition, the UE aggregation authorized information element (IE) may be included in the handover request message. The aggregated UEs or candidate aggregation-capable UE type may be indicated in the HO request. The QoS flow to UE ID or DRB mapping may also be included in the HO request message.

Accordingly, the gNB2 may send the handover request acknowledgment message to gNB1, including the RRCReconfiguration with synchronization of multiple UEs involved in the aggregation. The target gNB2 may only allow the HO of a subset of the aggregated UEs. In this case, the target gNB2 may send the Handover Request Acknowledge message to source gNB1 indicating which UE is allowed to HO and the corresponding RRCReconfiguration with synchronization. For the other UE not allowed to perform the HO, the target gNB2 may send the Handover Request Acknowledge message including the not allowed UE list or the cause value.

In addition, the target gNB2 may reconfigure the UEs for aggregation operation. For example, the target gNB may only admit a subset of QoS flows of UE1 and remove the aggregation of UE2. In some embodiments, the target gNB may involve more aggregation-capable UE to offload the traffic transmission of UE1. In this case, the Handover Request Acknowledge message may also include the RRCReconfiguration with sync of those to be aggregated UEs.

The source gNB1 may send the RRCReconfiguration message with reconfiguration with synchronization of multiple UEs to the traffic originating UE. The traffic originating UE may distribute the RRCReconfiguration with synchronization of those aggregated UE via internal non-specified connection or PC5 interface. The involved UEs may perform synchronization and random access towards the target cell. Upon the involved UEs sending the RRCReconfigurationComplete message, the UE may resume the aggregation based transmission or reception.

In some embodiments, the source gNB1 may send the RRCReconfiguration with synchronization to UE1 first. The UE1 may begin to perform the HO towards target gNB2. In this case, the HO procedure described before can be reused here. For example, the source gNB1 may send the early SN transfer (for the aggregated UE1's DRB to be delivered via aggregated UE2) to target gNB2. The early SN transfer may include the DRB ID, DL count or discard bitmap. Source gNB1 may still forward the duplicated or split PDCP SDU to target gNB2. Later when UE1 connect to the target gNB2, target gNB2 may send the HO success to source gNB1. Source gNB1 may send the SN status transfer to target gNB2. Later gNB2 may be responsible for the PDCP SN assignment. At this time, if the UE2 does not perform HO yet, the DL packet to be delivered via UE2 may be either buffered at the target gNB2 or the target gNB2 forward the DL packet to UE2 and UE2 deliver it to UE1. This forwarding can be kept until the gNB1 send the RRCReconfiguration with sync to UE2.

Moreover, the source gNB1 may first send RRCReconfiguration with synchronization to UE2. In this case, the UE1's PDCP entity may be anchored at source gNB1. gNB1 may forward the DLo r UL packet of UE1's DRB3 to be delivered via UE2 to gNB2. As such, the source gNB1 and target gNB1 may setup the data forwarding tunnel for UE1's DRB3 or UE2's Uu RLC channel. After the UE2 completes the HO procedure, the DL data can be forwarded from gNB1 to the gNB2 while UL data can be forwarded from gNB2 to the gNB1. When the source gNB1 later sends the RRCReconfiguration with synchronization to UE1, the UE1 may begin to connect to target gNB2. Meanwhile, source gNB1 may send the SN status transfer to target gNB2. The following procedure may reuse the legacy procedure of normal UE HO procedure.

### C. Handling Radio Link Failures

A signalling procedure may be performed for the multi-path UE detecting a radio link failure (RLF) or performing RRC reestablishment. The traffic originating UE 1 may be initially configured with both direct and indirect path. When the UE1 detects RLF of the direct path, UE1 may send the direct path failure (e.g., UE ID, failure type, or measurement result) to gNB via the indirect path. In addition, UE1 may adjust its uplink transmission. For example, the UE1 may suspend the transmission of direct path, re-route the packet to the indirect path, or set the primary path as indirect path. Upon receiving the direct path failure, the gNB may configure the UE1 to only use indirect path(s) for data transmission or reception. Meanwhile, the UE1 may continue to perform a reference signal received power (RSRP) measurement of neighboring cells and may send the measurement report to gNB. When the measurement of one intra-gNB neighboring cell is satisfactory, the gNB may configure the UE1 to connect to the new neighboring cell.

### D. Types of Path Switching

When UE1 and UE2 is configured to support multi-path delivery of UE1's DRB or signaling radio bearer (SRB), the UE1 and UE2 may be PC5 connected or aggregated via an internal connection. The multi-path delivery may be reconfigured based on the radio conditions and traffic load requirements. The following path switch scenarios may be considered.

Under the first scenario, the multi-path may be reconfigured from a direct path to an indirect path. This can be configured by gNB to remove the direct path and add the indirect path. Under the second scenario, the multi-path may be reconfigured from an indirect path to a direct path. This can be configured by gNB to remove the indirect path and add the direct path.

Under the third scenario, the multi-path may be reconfigured from a direct path to an indirect path and a direct path. This can be configured by gNB to add one more path via the RRC signalling on direct path. Before that, gNB may update the RLC channel or DRB configuration of the relay UE or aggregated UE. After that, the UE1 may use the two paths for data split or duplication based transmission.

Under the fourth scenario, the multi-path may be reconfigured from an indirect path to an indirect path and a direct path. This can be configured by gNB to add direct path via the RRC signalling. As such, the traffic originating UE1 may be initially connected to the network via the relay UE or aggregated UE. When the traffic originating UE1 receives the direct path configuration (e.g., via reconfiguration with synchronization), the UE may perform synchronization and random access with the gNB. The UE may then send the RRCReconfiguration Complete message to gNB. Afterward, the UE1 may use the two paths to send the data traffic.

Under the fifth scenario, the multi-path may be reconfigured from an indirect path and a direct path to a direct; path. In this case, the gNB may directly configure the traffic originating UE1 to use the direct path. The configuration of indirect path may be removed or deactivated, or totally released. However, for the PDCP SDU or PDU which already delivered to the aggregated UE or relay UE, the SDU or PDU may still be transmitted to the gNB before the deactivation or release. If the channel condition of aggregating relay UE is poor or even RLF is detected, the data lossless delivery can be guaranteed by the PDCP status report. For example, the gNB may send the PDCP status report to traffic originating UE1 via a direct path and the traffic originating UE1 retransmit the PDCP SDU or PDU not acknowledged by the gNB.

Under the sixth scenario, the multi-path may be reconfigured from an indirect path and direct path to an indirect path. In this case, the gNB may directly configure the traffic originating UE1 to use indirect path. The configuration of direct path may be removed or deactivated or the direct connection may be totally released. However, for the PDCP SDU or PDU which already delivered to PDCP or RLC channel of traffic aggregating UE, the SDU or PDU may still be transmitted to the gNB before the removal, deactivation, or the release. If the channel condition of traffic originating UE1 is poor or even RLF is detected, the data lossless delivery can be guaranteed by the PDCP status report. For example, the gNB may send the PDCP status report to traffic originating UE1 via indirect path and the traffic originating UE1 may re-transmit the PDCP SDU/PDU not acknowledged by gNB to the gNB via the indirect path.

### E. Process of Facilitating Handovers

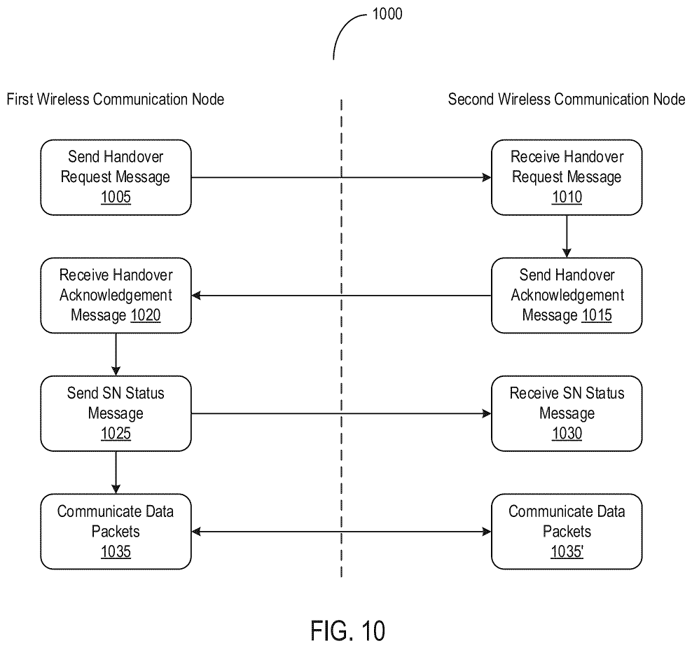

Referring now to FIG. 10 illustrates a flow diagram of a method 1000 of facilitating handovers. The method 1000 may be implemented using or performed by any of the components discussed herein, such as BS 102 or 202 or UE 104 or 204, among others. In brief overview, a first wireless communication node may send a handover request (1005). A second wireless communication node may receive the handover request (1010). The second wireless communication node may send a handover acknowledgement message (1015). The first wireless communication node may receive the handover acknowledgment message (1020). The first wireless communication node may send a sequence number (SN) status transfer message (1025). The second wireless communication node may receive the SN status transfer message (1030). The first wireless communication node and the second wireless communication node may communicate data packets (1035 and 1035′).

In further view, a first wireless communication node (e.g., BS 102 or 202) may provide, transmit, or otherwise send a handover request message to a second wireless communication node (e.g., BS 102 or 202) (1005). The handover request message may define, reference, or otherwise identify at least one wireless communication device (e.g., UE 104 or 204) in a UE-to-network relay configuration or an UE aggregation configuration. In some embodiments, the handover request may identify or include candidate aggregation-capable UE information. The candidate aggregation-capable UE information may identify or include an identifier for the at least one wireless communication device a protocol data unit (PDU) session resource request, among others. In some embodiments, the handover request message may identify or include a mapping of a quality of service (QoS) flow with the identifier for the at least one wireless communication device or a data radio bearer (DRB), among others. The second wireless communication node may retrieve, identify, or otherwise receive the handover request from the first wireless communication node (1010).

In conjunction with the handover request, the first wireless communication node may communicate tunnel configuration information for a forwarding tunnel of the DRB with the second wireless communication node. The second wireless communication node may use the tunnel configuration information to communicate with the first wireless communication node. In some embodiments, the first wireless communication node may provide, transmit, or otherwise send the tunnel configuration information to the second wireless communication node. The tunnel configuration may be sent to the second wireless communication node with a corresponding DRB identifier. The sending of the tunnel configuration information and the corresponding DRB identifier may be in response to receiving a forwarding request from the second wireless communication node. In some embodiments, the first wireless communication node may retrieve, identify, or otherwise receive the tunnel configuration information from the second wireless communication node.

The second wireless communication node may provide, transmit, or otherwise send a handover request acknowledgement message to the first wireless communication node (1015). The handover request acknowledge message may reference or identify the at least one wireless communication device with which a handover is permitted. In some embodiments, the handover request acknowledge message may include or identify a radio resource control (RRC) reconfiguration message (e.g., RRCReconfiguration). The RRC reconfiguration message may include or contain information required to access the second wireless communication node corresponding to the at least one wireless communication device. In some embodiments, the handover request acknowledge message may reference or identify at least one second wireless communication device (e.g., UE 104 or 204) with which a handover is not allowed or may include at least one cause value, among others. The first wireless communication node may retrieve, identify, or otherwise receive the handover acknowledgment message from the second wireless communication node (1020).

The first wireless communication node may provide, transmit, or otherwise send a sequence number (SN) transfer message to the second wireless communication node (1025). The SN transfer message may identify or include a DRB identifier or a downlink (DL) count, among others. In some embodiments, the SN transfer message may be sent by the first wireless communication node in response to receipt of path switch information from the second wireless communication node. In some embodiments, the SN transfer message may be sent by the first wireless communication node in response to receiving an end marker from a user plane function (UPF). In some embodiments, the first wireless communication node may send the SN transfer message in response to sending a RRC reconfiguration message. The RRC reconfiguration message may identify, include, or otherwise contain the information required to access the second wireless communication node by a wireless communication device. In some embodiments, the first wireless communication node may perform reordering, duplication detection, discarding, or delivery of a PDCP service data unit (SDU) to a UPF, prior to sending the SN transfer message. The second wireless communication node may retrieve, identify, or otherwise receive the SN transfer message from the first wireless communication node (1030). In some embodiments, the second wireless communication node may perform reordering, duplication detection, discarding, or delivery of PDCP SDUs after receiving the SN transfer message from the first wireless communication node.

The first wireless communication node and the second wireless communication node may communicate data packets (1035 and 1035′). In some embodiments, the second wireless communication node may transmit, provide, or otherwise send a packet data convergence protocol (PDCP) protocol data unit (PDU) packet with a PDCP encryption or PDCP compression algorithm configured at the second wireless communication node. The first wireless communication node may retrieve, obtain, or otherwise receive the PDCP PDU from the second wireless communication node. In some embodiments, the first wireless communication node may provide, transmit, or otherwise send path switch information to a wireless communication device. The path switch information may include or identify a control PDU comprising at least one of: a DRB identifier, an indicator for an uplink (UL) or downlink (DL) direction, a path switch indication, or an indicator for the PDCP encryption or PDCP compression algorithm of the second wireless communication node, among others.

In some embodiments, the first wireless communication node may provide, transmit, or otherwise send a split or duplicated PDCP service data unit (SDU) of a DRB to the second wireless communication node. The second wireless communication node may retrieve, obtain, or otherwise receive the split or duplicated PDCP SDU from the first wireless communication node. In some embodiments, the first wireless communication node may provide, transmit, or otherwise send a DL count to the second wireless communication node, in response to receiving a DL PDCP PDU at a lower layer. The second wireless communication node may retrieve, obtain, or otherwise receive the DL count from the first wireless communication node.

### F. Process of Completing Handovers

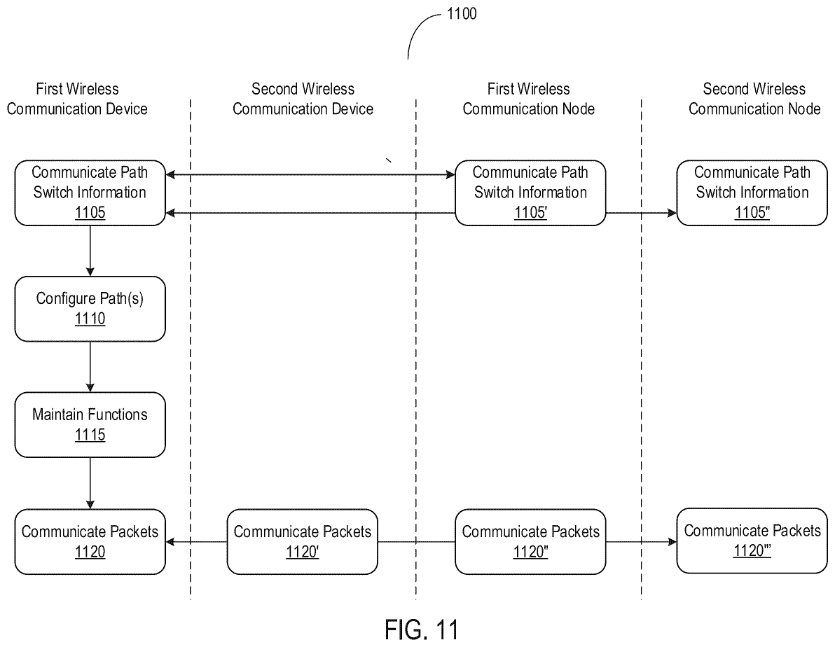

Referring now to FIG. 11, depicted is a flow diagram of a method 1110 of completing handovers. The method 1100 may be implemented using or performed by any of the components discussed herein, such as BS 102 or 202 or UE 104 or 204, among others. In brief overview, a first wireless communication device may communicate a path switch information with a first wireless communication node or a second wireless communication node (1105, 1105′, or 1105″). The first wireless communication device may configure one or more paths (1110). The first wireless communication device may maintain functions (1115). The first wireless communication device may communicate packets with a second wireless communication device, the first wireless communication node, or the second wireless communication node, among others (1120, 1120′, 1120″, or 1120′″).

In further detail, a first wireless communication device (e.g., UE 104 or 204) may communicate a path switch information with a first wireless communication node (e.g., BS 102 or 202) or a second wireless communication node (e.g., BS 102 or 202) (1105, 1105′, or 1105″). In some embodiments, the first wireless communication device may retrieve, obtain, or otherwise receive the path switch information directly from the second wireless communication node or indirectly via a second wireless communication device (e.g., UE 102 or 202). The path switch information may include control protocol data unit (PDU). The control PDU may identify or include one or more of: a DRB identifier, an indicator for an uplink (UL) or downlink (DL) direction, a path switch indication, or an indicator for a PDCP encryption or compression algorithm configured by the second wireless communication node, among others. In some embodiments, the path switch information may identify that a protocol data convergence protocol (PDCP) PDU of a data radio bearer (DRB) is switched to a PDCP encryption or PDCP compression algorithm configured by the second wireless communication node.

In some embodiments, the path switch information may be received from the first wireless communication node, responsive to the first wireless communication node sending a sequence number (SN) transfer message for a data radio bearer (DRB). In some embodiments, the path switch information may be received from the first wireless communication node, responsive to the first wireless communication node receiving a UE context release from the second wireless communication node. In some embodiments, the first wireless communication device may provide, transmit, or otherwise send the path switch information to the first wireless communication node via the second wireless communication device.

In some embodiments, the first wireless communication device may send the path switch information for a data radio bearer (DRB) to the first wireless communication node via the second wireless communication device. In some embodiments, the first wireless communication device may receive the path switch information for a DRB (e.g., a second DRB) from the second wireless communication. Upon receipt, the first wireless communication device may send the path switch information to the first wireless communication node via the second wireless communication device. In some embodiments, the first wireless communication device may send the PDCP PDU of the DRB to the first wireless communication node via the second wireless communication device.

The first wireless communication device may configure one or more paths (1110). One path may be a direct path to directly communicatively couple the first wireless communication device with one of the wireless communication nodes. One path may be an indirect path to indirectly communicatively couple the first wireless communication device with one of the wireless communication nodes. In some embodiments, the first wireless communication device may configure a path to suspend transmission on a direct path, re-route packets to an indirect path, or set an indirect path as a primary path. In some embodiments, the first wireless communication device may retrieve, identify, or otherwise receive a configuration from the wireless communication node. In some embodiments, the configuration may identify or include: an addition, modification, or a removal of the direct path; an addition, modification, or removal of the indirect path; activate or deactivate the direct path; or activate or deactivate indirect path, among others.

The first wireless communication device may establish, perform, or otherwise maintain functions for the one or more paths (1115). In some embodiments, the first wireless communication device may maintain a first function for downlink (DL) packets communicated via the direct path using a PDCP entity. The first function may be to perform at least one of decompression, deciphering, and removal of robust header compression (ROHC) header based on a configuration by the first wireless communication node. In some embodiments, the first wireless communication device may maintain a second function for DL packets communicated via the indirect path using the PDCP entity. The second function is to perform at least one of decompression, deciphering, and removal of robust header compression (ROHC) header based on a configuration by the second wireless communication node. In some embodiments, the first wireless communication device may maintain a third function to perform reordering, duplication detection, discarding, or delivery of PDCP service data units (SDUs) to an upper layer, among others.

In some embodiments, the first wireless communication device may set, configure, or otherwise maintain a PDCP SN allocation for uplink (UL) packets communicated via the direct path and the indirect path. In some embodiments, the first wireless communication device may set or maintain a first configuration for processing split or duplicated UL packets communicated via the direct path. In some embodiments, the first wireless communication device may set or maintain a second configuration for processing the split or duplicated UL packets communicated via the indirect path. The first and second configuration may be separate PDCP configurations to perform compression, ciphering, or addition of a robust header compression (ROHC) header, among others.

In some embodiments, the first wireless communication device may communicate (e.g., PDCP SDU or PDU) in a UE-to-network relay configuration or UE aggregation configuration, at least partially concurrent with deactivation of a path. In some embodiments, the first wireless communication device may retrieve, obtain, or receive the RRC reconfiguration message containing the information required to access the second wireless communication node from the first wireless communication node to the plurality of wireless communications devices in the UE aggregation configuration. In some embodiments, the first wireless communication device may carry out or perform the aggregation-based communication with the plurality of wireless communication device, responsive to a RRC reconfiguration of each wireless communication device.

The first wireless communication device may communicate packets with a second wireless communication device, the first wireless communication node, or the second wireless communication node, among others (1120, 1120′, 1120″, or 1120′″). The first wireless communication device may receive DL packets via the direct or indirect path from one of the wireless communication nodes. In some embodiments, the first wireless communication device may retrieve, obtain, or otherwise receive DL packets of a DRB from the first wireless communication node via the second wireless communication device (e.g., using the indirect path). In some embodiments, the first wireless communication device may receive a DL packet via the second wireless communication device over an indirect path. In some embodiments, the first wireless communication device may receive a DL packet from the second wireless communication node via the direct path. In some embodiments, the first wireless communication device may retrieve, obtain, or otherwise receive a radio link channel (RLC) SDU or PDU from the second wireless communication device, concurrent with or prior to the second wireless communication device re-establishing the RLC.

In some embodiments, the first wireless communication device may retrieve, obtain, or otherwise receive a status report (e.g., PDCP status report) for the DRB from the second wireless communication device. In some embodiments, the status report may identify or include one or more of: an indicator identifying whether a PDCP PDU is successfully transmitted to the first wireless communication node; an identifier for the first wireless communication device; a DRB identifier; a UL count; or a receiver status of a UL PDCP SDU, among others. In some embodiments, the first wireless communication device may resend or retransmit a PDCP PDU in accordance with the PDCP status report.

In some embodiments, the first wireless communication device may transmit the PDCP PDU to the second wireless communication device for retransmission of a corresponding, missing PDCP PDU. In some embodiments, the first wireless communication device may refrain from determination of successful transmission of the UL PDCP data PDU to the second wireless communication device, responsive to successful transmission of a corresponding UL PDCP PDU to the second wireless communication device.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method of facilitating handovers, comprising:
communicating, by a first wireless communication node, tunnel configuration information for a forwarding tunnel of a data radio bearer (DRB) with a second wireless communication node,
wherein the second wireless communication node is configured to use the tunnel configuration information to communicate with the first wireless communication node.

2. The method of claim 1, further comprising sending, by the first wireless communication node, a sequence number (SN) transfer message to the second wireless communication node.

3. The method of claim 2, wherein sending the SN transfer message further comprises sending the SN transfer message in response to receiving path switch information from the second wireless communication node.

4. The method of claim 2, wherein sending the SN transfer message further comprises sending the SN transfer message in response to receiving an end marker from a user plane function (UPF).

5. The method of claim 2, wherein sending the SN transfer message further comprises sending the SN transfer message in response to sending a RRCReconfiguration message containing the information required to access the second wireless communication node to a wireless communication device.

6. The method of claim 5, wherein the SN transfer message comprises at least one of a DRB identifier or a downlink (DL) count.

7. The method of claim 2, further comprising receiving, by the first wireless communication node, from the second wireless communication node, a packet data convergence protocol (PDCP) protocol data unit (PDU) packet with a PDCP encryption or PDCP compression algorithm configured at the second wireless communication node.

8. The method of claim 7, further comprising sending, by the first wireless communication node, path switch information to the wireless communication device, responsive to receiving the PDCP PDU from the second wireless communication node.

9. The method of claim 8, wherein the path switch information includes a control PDU comprising at least one of: a DRB identifier, an indicator for an uplink (UL) or downlink (DL) direction, a path switch indication, or an indicator for the PDCP encryption or PDCP compression algorithm of the second wireless communication node.

10. The method of claim 1, wherein communicating the tunnel configuration information further comprises sending, to second wireless communication node, the tunnel configuration information and a corresponding DRB identifier, responsive to receiving a forwarding request from the second wireless communication node.

11. The method of claim 1, further comprising sending, by the first wireless communication node, a split or duplicated PDCP service data unit (SDU) of a DRB to the second wireless communication node.

12. The method of claim 11, further comprising sending, by the first wireless communication node, a DL count, to the second wireless communication node, responsive to receipt of a DL PDCP PDU at a lower layer.

13. The method of claim 1, further comprising performing, by the first wireless communication node prior to sending the SN transfer message, at least one of: reordering, duplication detection, discarding, or delivery of a PDCP SDU to a UPF.

14. The method of claim 13, further comprising performing, by the second wireless communication node, at least one of the reordering, duplication detection, discarding, or delivery of PDCP SDUs to the UPF after receiving the SN transfer message.

15. A method of facilitating handovers, comprising:
communicating, by a second wireless communication node, tunnel configuration information for a forwarding tunnel of a data radio bearer (DRB) with a first wireless communication node,
wherein the second wireless communication node is configured to use the tunnel configuration information to communicate with the first wireless communication node.

16. A second wireless communication node, comprising:
at least one processor configured to:
communicate, via a transceiver, tunnel configuration information for a forwarding tunnel of a data radio bearer (DRB) with a first wireless communication node,
wherein the second wireless communication node is configured to use the tunnel configuration information to communicate with the first wireless communication node.

17. A first wireless communication node, comprising:
at least one processor configured to:
communicate, via a transceiver, tunnel configuration information for a forwarding tunnel of a data radio bearer (DRB) with a second wireless communication node,
wherein the second wireless communication node is configured to use the tunnel configuration information to communicate with the first wireless communication node.

18. The first wireless communication node of claim 17, wherein the at least one processor is configured to send, via a transceiver, a sequence number (SN) transfer message to the second wireless communication node.

19. The first wireless communication node of claim 18, wherein to send the SN transfer message further comprises to send the SN transfer message in response to receiving path switch information from the second wireless communication node.

20. The first wireless communication node of claim 18, wherein to send the SN transfer message further comprises to send the SN transfer message in response to receiving an end marker from a user plane function (UPF).
